(19) United States
(12) Patent Application Publication
(10) Pub. No.: US 2024/0159854 A1
(43) Pub. Date: May 16, 2024

(54) POSITIONING REFERENCE SIGNAL BASED POSITIONING

(71) Applicant: Sony Group Corporation, Tokyo (JP)

(72) Inventors: Erik BENGTSSON, Eslöv (SE); Kun ZHAO, Malmö (SE); Olof ZANDER, Södra Sandby (SE); Jose FLORDELIS, Lund (SE); Fredrik RUSEK, Eslöv (SE)

(21) Appl. No.: 18/282,533

(22) PCT Filed: Mar. 17, 2022
(86) PCT No.: PCT/EP2022/057088

§ 371 Date: Sep. 17, 2023

(30) Foreign Application Priority Data
Mar. 31, 2021 (SE) 2150409-7

(51) Int. Cl. G01S 5/00; G01S 5/02; H04W 24/10

(52) U.S. Cl. CPC G01S 5/0036; G01S 5/0273; H04W 24/10

(57) ABSTRACT

A method of operating a terminal node (310) configured to communicate with one or more network nodes using a re-configurable relaying device (330), RRD, is provided. The RRD is re-configurable to provide spatial filters, each one of the spatial filters being associated with a respective spatial direction into which incident signals are selectively transmitted by the RRD. The method comprises receiving (6002) a plurality of positioning reference signals, PRSs, transmitted by the one or more network nodes, and, upon a first PRS (363) and a second PRS (362) of the plurality of PRSs being received from a same network node (320) of the one or more network nodes, the first PRS (363) being received along a path which is relayed at the RRD (330): transmitting (6006) a measurement report message comprising positioning information for the terminal node (310) based on at least the first PRS (363) and second PRS (362).

### TECHNICAL FIELD

Various examples generally relate to positioning of nodes in wireless communication network systems. Various examples specifically relate to improving positioning which is based on positioning reference signals transmitted between nodes in wireless communication network systems.

### BACKGROUND

Positioning for 5G New Radio (NR) using Positioning Reference Signals (PRS) is a well-established area within 3rd Generation Partnership Project (3GPP) networks. Positioning in 3GPP using PRS requires at least three time-synchronized transmitter nodes, for example base stations, gNBs, with known positions. For example, each gNB transmits a corresponding PRS and a terminal node, for example a user equipment UE, measures the time-of-flight for each PRS. Accuracy of the measured time-of-flight depends on and may vary with the accuracy of the synchronization between gNB and UE. The PRSs may be transmitted in predefined positioning subframes grouped by several consecutive subframes, which are termed “positioning occasions”. Positioning occasions may occur periodically with certain periodicity. For example, in 3GPP TS 36.211 a periodicity is defined and may be 160, 320, 640, or 1280 subframes (or milliseconds) and a number of consecutive subframes can be 1, 2, 4, or 6 subframes. PRS occasions in each cell of the network may be synchronized. Since the UE may not be perfectly time-synchronized with the gNBs, the three time measurements may be subtracted from each other to form two time-differences. Based on a geometric calculation and the positions of the gNBs, the UE position may be obtained. In wireless communications, typically multipath propagation may occur which implies that one or some of the PRS may be reflected at buildings or other environmental objects. The reflected PRS may then arrive at the UE with a delay compared to the PRS received along a line-of-sight (LOS) path. Typically, any reflected PRS is removed from consideration, i.e. only the PRS received first from a specific gNB is considered for positioning, as it is assumed that this first received PRS is received along the LOS path.

As previously noted, PRS based positioning requires at least three time-synchronized transmitter nodes in radiofrequency reach of the UE, preferably with LOS paths between each transmitter node and the UE. However, such a scenario is not always present, thus reducing the applicability of PRS based positioning.

### SUMMARY

Accordingly, there is a need for improved positioning techniques.

This need is met by the features of the independent claims. The features of the dependent claims define examples.

A method is provided for operating a terminal node. The terminal node, for example a user equipment in a wireless communication network, is configured to communicate with one or more network nodes using a Re-configurable Relaying Device.

For example, the use of Re-configurable Relaying Devices (RRD) may be envisioned in order to increase a coverage area for wireless communication. RRDs are sometimes also referred to as Re-configurable Reflective Devices or reflecting Large Intelligent Surfaces (LIS). See, e.g., Sha Hu, Fredrik Rusek, and Ove Edfors: “Beyond massive MIMO: The potential of data transmission with large intelligent surfaces.” IEEE Transactions on Signal Processing 66.10 (2018): 2746-2758.

An RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a data radio channel are accepted and an output spatial direction into which the incident signals are reflected by the array of antennas can be re-configured, by changing a phase relationship between the antennas. The data radio channel may refer to a radio channel specified by the 3GPP standard. In particular, the data radio channel may refer to a physical radio channel. The data radio channel may offer several time/frequency-resources for communication between different communication nodes of a communication system. Additionally, or as an alternative, the array of antennas can be active. For example, incident signals on a data radio channel may be received in an input spatial direction and retransmitted in an output spatial direction. The input spatial direction and the output spatial direction may be reconfigurable. The signal power level of the retransmitted signal may be configurable. Thus, the RRD may act as a repeater, e.g. on an analogue physical communication layer without decoding and encoding the data signal. In this description, the term “relayed” will be used when a signal is, depending on the type of RRD, reflected or repeated at the RRD.

According to the method, the RRD is re-configurable to provide spatial filters, each one of the spatial filters being associated with a respective spatial direction into which incident signals are selectively transmitted by the RRD. As explained above, selectively transmitting the incident signals by the RRD may comprise reflecting the incident signals or repeating the incident signals, depending on the type of RRD. For example, the RRD provides multiple spatial filters and is reconfigurable to selectively implement one of the multiple spatial filters. Each one of the multiple spatial filters is associated with a respective spatial direction into which incident radio signals are selectively relayed by the RRD. In particular, in the case of a semi-passive RRD, each one of the multiple spatial filters is associated with a respective spatial direction into which incident radio signals are selectively reflected by the RRD. Furthermore, according to the method, a plurality of positioning reference signals, PRSs, transmitted by the one or more network nodes, are received at the terminal node. Upon receiving a first PRS and a second PRS of the plurality of PRSs from a same network node of the one or more network nodes, with at least one of the first and second PRSs, e.g. the first PRS, being received along a path which is relayed at the RRD, a measurement report message comprising positioning information for the terminal node based on at least the first PRS and second PRS is transmitted. For example, the measurement report message may comprise time measurements concerning the time of arrival of the first PRS and the second PRS at the terminal node. In another example, the measurement report message may comprise a time difference of arrival of the first PRS and the second PRS.

It is to be noticed that the definitions “first PRS” and “second PRS” do not to define a temporal order in which the PRSs are received at the terminal node. In particular, the first PRS received along a propagation path which is relayed at the RRD may be received at the terminal node after the second PRS has been received at the terminal node, for example in case the second PRS has been received along a propagation path which is not relayed at the RRD, for example along a LOS propagation path.

A position of the RRD may be known in the network. By including, in the measurement report message, a PRS which is relayed at the RRD with known position, this PRS may additionally be considered in geometric calculations for determining the position of the terminal node. Thus, a number of transmitter nodes required for positioning may be reduced. Further, a positioning accuracy may be increased due to the inclusion of the RRD in the positioning procedure.

In addition, a method of operating a positioning node configured to communicate with one or more terminal nodes using a re-configurable relaying device, RRD is provided. The RRD is re-configurable to provide spatial filters. Each one of the spatial filters is associated with a respective spatial direction into which incident signals are selectively transmitted by the RRD. The method comprises obtaining a measurement report message comprising positioning information for a terminal node of the one or more terminal nodes. The positioning information is based on at least a first PRS and a second PRS received from a same network node. The first PRS is received along a path which is relayed at the RRD. A position of the terminal node is determined based on the positioning information and a position of the RRD.

Thus, multiple PRSs from a same transmitter node, e.g. a same base station, gNB, may be considered in geometric calculations of the position of the terminal node, for example one PRS transmitted along a path relayed at the RRD with known position and another PRS transmitted along a line of sight, LOS, path. In another example, only one PRS may be sent from the gNB, but two copies may be received at the UE, e.g. one copy along LOS and another copy along a path relayed at the RRD with known position. Both received copies of the PRS may be considered in geometric calculations of the position of the terminal node. Thus, a number of transmitter nodes required for positioning may be reduced and/or the positioning accuracy may be increased.

A terminal node is provided which comprises at least an antenna arrangement, a transceiver and control circuitry. The terminal node may comprise for example a user equipment operated in wireless communication network. The terminal node is configured to communicate with one or more network nodes using an RRD. The RRD is re-configurable to provide spatial filters. Each one of the spatial filters is associated with a respective spatial direction into which incident signals are selectively transmitted by the RRD. The terminal node is configured to receive a plurality of PRSs transmitted by the one or more network nodes. Upon a first PRS and a second PRS of the plurality of PRSs being received from a same network node of the one or more network nodes, and the first PRS being received along a path which is relayed at the RRD, the terminal node is configured to transmit a measurement report message comprising positioning information for the terminal node based on at least the first PRS and second PRS.

A positioning node is provided comprising an antenna arrangement, a transceiver and control circuitry. The positioning node may comprise for example a base station or a location server of a wireless communication network, or a combination thereof. The positioning node is configured to communicate with one or more terminal nodes using an RRD. The RRD is re-configurable to provide spatial filters. Each one of the spatial filters is associated with a respective spatial direction into which incident signals are selectively transmitted by the RRD. The positioning node is configured to obtain a measurement report message comprising positioning information for a terminal node of the one or more terminal nodes. The positioning information is based on at least a first PRS and a second PRS received from a same network node. The first PRS is received along a path which is relayed at the RRD. The positioning node is configured to determine a position of the terminal node based on the positioning information and a position of the RRD.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at transmitter nodes of the communication system and further schematically illustrates an RRD towards which one of the multiple transmit beams is directed according to various examples.

FIG. 4 schematically illustrates details with respect to the RRD.

FIG. 5 schematically illustrates a further scenario of multiple downlink transmit beams used at transmitter nodes and an RRD towards which one of the multiple transmit beams is directed according to various examples.

FIG. 6 schematically illustrates a method for operating a terminal node.

FIG. 7 schematically illustrates a method for operating a positioning node.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a central processing unit (CPU), a graphics processing unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a 3rd Generation Partnership Project (3GPP)-specified cellular network (NW). In such case, the transmitter node can be implemented by a base station (BS) of the RAN, and the one or more receiver nodes can be implemented by terminals (also referred to as user equipment, UE). It would also be possible that the transmitter node is implemented by a UE and the one or more receiver nodes are implemented by a BS and/or further UEs.

Hereinafter, for the sake of simplicity, various examples will be described with respect to an example implementation of the transmitter node by a BS and the one or more receiver node by UEs—i.e., to downlink (DL) communication; but the respective techniques can be applied to other scenarios, e.g., uplink (UL) communication and/or sidelink communication.

According to various examples, the transmitter node can communicate with at least one of the receiver nodes via an RRD.

The RRD may include an antenna array. The RRD may include a meta-material surface. In examples, an RRD may include a reflective antenna array (RAA).

There are many approaches for how RRDs may be integrated into 3GPP-standardized RANs.

In an exemplary case, the NW operator has deployed the RRDs and is therefore in full control of the RRD operations and positions of the RRDs. The UEs, on the other hand, may not be aware of the presence of any RRD, at least initially, i.e., it is transparent to a UE whether it communicates directly with the BS or via an RRD. The RRD essentially functions as a coverage-extender of the BS. The BS may have established a control link with the RRD. The control link may be in-band, i.e. related signaling is communicated within the communication bandwidth of the communication between the BS and UE. This may reduce the amount of resources available for communication with/positioning of the UE. The control link may be out-of-band, wherein a distinct band is used which may be separate from the communication bandwidth of the communication between the BS and UE. The control link may also be implemented via a wired link.

According to another exemplary case, it might be a private user or some public entity that deploys the RRD. Further, it may be that the UE, in this case, controls RRD operations. The BS, on the other hand, may not be aware of the presence of any RRD and, moreover, may not have control over it/them whatsoever. The UE may gain awareness of the presence of RRD by means of some short-range radio technology, such as Bluetooth, wherein Bluetooth may refer to a standard according to IEEE 802.15, or WiFi, wherein WiFi may refer to a standard according to IEEE 802.11, by virtue of which it may establish a control link with the RRD. It is also possible that the UE gains awareness of the presence of RRD using UWD (Ultra wideband) communication. Using UWB may offer better time resolution due to the wider bandwidth compared to other radio technologies.

In a further exemplary case, neither the UE nor the BS are aware of the presence of the RRD. The RRD may be transparent with respect to a communication between the UE and the BS on a data radio channel. The RRD may gain awareness of the UE and/or the BS and re-configure itself based on information obtained from the UE and/or BS.

The three exemplary cases described above are summarized in TAB. 1 below.

TABLE 1
Scenarios for RRD integration into cellular NW

| Scenario | Description | Explanation |
|---|---|---|
| A | BS-RRD | BS controls the RRD and/or can obtain |
| | control link | information from the RRD. A control link is |
| | | established between the BS and the RRD. |
| B | UE-RRD | UE controls the RRD and/or can obtain |
| | control link | information from the RRD. A control link is |
| | | established between the UE and the RRD. |
| C | transparent | RRD re-configures itself based on information |
| | RRD | obtained from the UE and/or BS. No control link |
| | | is established between the RRD and the UE or |
| | | the BS. |

Hereinafter, techniques will be described which facilitate communication between a transmitter node—e.g., a BS—and one or more receiver nodes—e.g., one or more UEs—using an RRD.

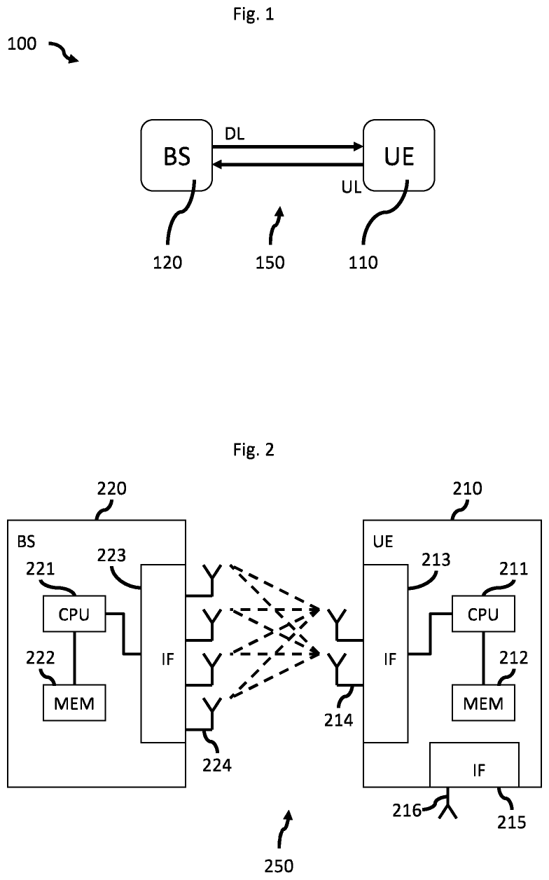

FIG. 1 schematically illustrates a communication system 100. The communication system 100 includes two nodes 110, 120 that are configured to communicate with each other via a data radio channel 150. In the example of FIG. 1, the node 120 is implemented by an access node (AN), more specifically a BS, and the node 110 is implemented by a UE. The BS 120 can be part of a cellular NW (not shown in FIG. 1). As a general rule, the techniques described herein could be used for various types of communication systems, e.g., also for peer-to-peer communication, etc. For sake of simplicity, however, hereinafter, various techniques will be described in the context of a communication system that is implemented by a BS 120 of a cellular NW and a UE 110.

As illustrated in FIG. 1, there can be DL communication, as well as UL communication.

FIG. 2 illustrates details with respect to the BS 220. The BS 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the BS 220 and the UE 210 on the data radio channel 250. The BS 220 includes an interface 223 that can access and control multiple antennas 224. Likewise, the UE 210 includes an interface 213 that can access and control multiple antennas 214.

The UE 210 may comprise a further interface 215 that can access and control at least one antenna 216 to transmit or receive a signal on a radio channel different from the data radio channel 250. Interface 215 and antenna 216 may enable communicating signals by means of short-range radio technologies, such as Bluetooth or WiFi.

While the scenario of FIG. 2 illustrates the antennas 224 being coupled to the BS 220, as a general rule, it would be possible to employ transmit-receive points (TRPs) that are spaced apart from the BS 220.

The interfaces 213, 223 may each include a transceiver for communicating radio signals via the antennas 214, 224. For example, the interfaces 213, 223 can each include one or more transmit (TX) chains and one or more receive (RX) chains. For instance, such RX chains can include low noise amplifiers, analogue to digital converters, mixers, etc. Analogue and/or digital beamforming would be possible.

Phase-coherent transmitting and/or receiving (communicating) can be implemented across the multiple antennas 214, 224. The BS 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Thereby, the spatial data stream can be directed. The spatial data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

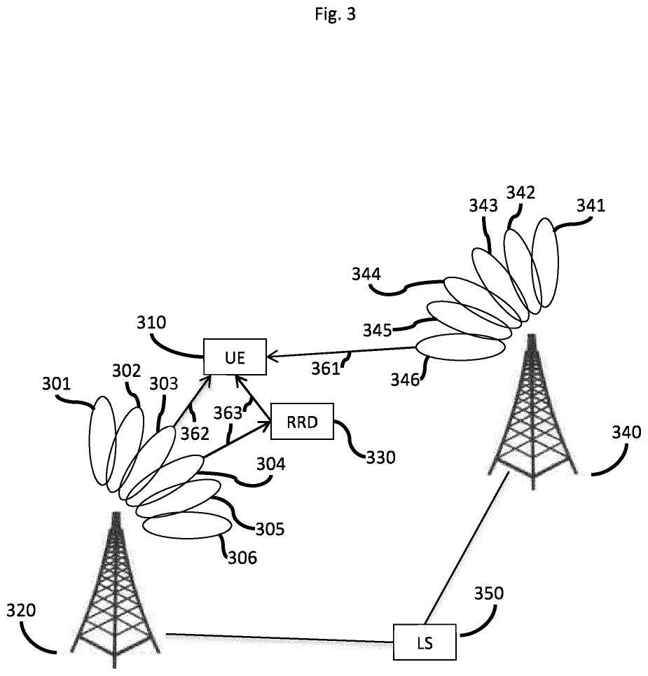

FIG. 3 illustrates DL TX beams 301-306 used by the BS 320. Here, the BS 320 activates the beams 301-306 on different resources (e.g., different time-frequency resources, and/or using orthogonal codes/precoding) such that the UE 310 can monitor and identify respective signals transmitted on the DL TX beams 301-306. The signals transmitted on the DL TX beams 301-306 may comprise positioning reference signals, PRSs.

A further BS 340 may also activate beams 341 to 346 on different resources such that the UE 310 can monitor and identify respective signals transmitted on the DL TX beams 341 for 346. The signals transmitted on the DL TX beams 341 to 346 may also comprise PRSs. One or more further BSs may be present, but not shown for reasons of clarity, providing further PRSs.

Transmission of the PRSs in the DL TX beams 301 to 306 and 341 to 346 may be coordinated and synchronized by a location server (LS) 350 coupled to BS 320 and BS 340.

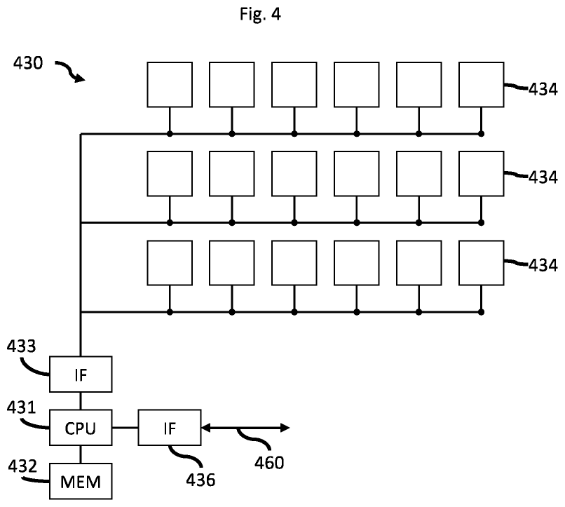

It is possible that the BS 320 transmits signals to the UE 310 via an RRD 330. In the scenario of FIG. 3, the downlink transmit beam 304 is directed towards the RRD 330. Thus, whenever the BS 320 transmits signals to the UE 310 using the downlink transmit beam 304—e.g., a PRS—, a spatial filter is provided by the RRD 330. The spatial filter is associated with a respective spatial direction into which the incident signals are then selectively reflected by the RRD 330. Details with respect to the RRD 330 are illustrated in connection with FIG. 4.

FIG. 4 illustrates aspects in connection with the RRD 430. For example, the RRD 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The RRD 430 thus provides coverage extension by reflection of radio-frequency (RF) signals. A translation to the baseband may not be required. The antennas 434 may induce an amplitude shift by attenuation.

In some examples, the antennas 434 can be active elements and may provide forward amplification without translation of signals transmitted on the data radio channel to the base band. The antennas 434 may amplify and forward the signals. This is different, to, e.g., decode-and-forward repeater functionality.

The RRD 430 includes an antenna interface 433 which controls the array of antennas 434. A processor 431 can activate respective spatial filters one after another. The RRD 430 further includes an interface 436 for receiving and/or transmitting signals on a radio channel 460 different from the data radio channel reflected at the array of antennas 434. Interface 436 may enable communicating signals by means of short-range radio technology, such as Bluetooth or WiFi. Interface 436 may enable communicating signals by means of a wired connection.

The RRD 430 includes a memory 432 and the processor 431 can load program code from the non-volatile memory 432 and execute the program code. Executing the program code causes the processor 431 to perform techniques as described herein.

FIG. 4 is only one example implementation of the RRD. Other implementations are conceivable. For example, a meta-material surface not including distinct antenna elements may be used. The meta-material can have a configurable refraction index. To provide a re-configurable refraction index, the meta-material may be made of repetitive tunable structures that have extensions smaller than the wavelength of the incident RF signals.

According to various examples, positioning of a UE, i.e. determining a position of a user equipment, may be assisted by making use of an RRD as will be described in the following. In the following description, it is assumed that a single RRD is present. However, it is clear to a person skilled in the art that the described techniques may be extended to more than one RRD.

As shown in FIG. 3, UE 310 may receive a PRS 361 transmitted from BS 340 using downlink transmit beam 346. Furthermore, UE 310 may receive a PRS 362 transmitted from the BS 320 using downlink transmit beam 303, and additionally UE 310 may receive a PRS 363 transmitted from the same BS 320 using downlink transmit beam 304 and reflected at RRD 330.

It is assumed that UE 310 is aware of the fact that the PRS 363 has been reflected by RRD 330 and not by any other environmental object. For example, the UE 310 may obtain by communicating with RRD 330 via interfaces 215 and 436, for example via Bluetooth or Wi-Fi, a position of RRD 330 and may determine that the PRS 363 has been reflected by RRD 330 based on an angle of arrival of PRS 363 at UE 310. In other examples, the UE 310 may determine that the PRS 363 has been reflected by RRD 330 based on information encoded in the reflected PRS 363. For example, RRD may vary the intensity of the reflected signal in a controlled way, i.e. the reflected signal “flickers” in a controlled way, which is known to the UE. In a further example, each PRS 362, 363 may include an identifier of the DL TX beam 303, 304 with which the PRS is transmitted. Before transmitting the PRSs, the base station 320 may transmit a message to the UE 310 indicating that DL TX beam 304 is directed to an RRD, i.e. RRD 330.

As a result, the UE 310 receives two PRSs from the same BS 320, PRS 362 which is not reflected at RRD 330 and assumed to be transmitted along a line of sight (LOS) between BS 320 and UE 310, and PRS 363 which is reflected at RRD 330 and assumed to be transmitted along a LOS between RRD 330 and UE 310 and a LOS between BS 320 and RRD 330. The UE may transmit a measurement report message based on both, PRS 362 and PRS 363. For example, the UE 310 may transmit two timing values indicating the time of arrival of the two PRSs 362, 363, or the UE 310 may transmit a time difference of arrival of the two timing values. Additionally, the UE 310 may transmit within the same measurement report message or in a separate measurement report message a timing value concerning the PRS 361 received from BS 340, or the UE 310 may transmit a time difference of arrival of pairs of timing values of PRSs 361, 362, and 363. It is clear that, where the UE 310 receives further PRSs from further base stations, timing information values concerning these further PRSs are also reported in the same or in a separate measurement report message.

The one or more measurement report messages may be transmitted to the location server 350 via any of the BSs 320, 340 or any other base station at which the UE 310 is currently registered. At the location server, geometric calculations may be performed based on the received timing values for determining the position of the UE 310. The geometric calculations may be based additionally on the positions of the BSs 320, 340 as well as the position of the RRD 330. The positions of the BSs 320, 340 may be known to the location server, for example by entries in a corresponding database. The position of the RRD 330 may also be known to the location server by entries in a corresponding database. However, the position of the RRD 330 may also be known or determined by the UE 310, for example based on a communication between the UE 310 and the RRD 330, for example via Bluetooth or Wi-Fi, and may be transmitted from the UE 310 to the location server 350, for example via any one of BSs 320, 340. The position of the RRD 330 may be included in the above measurement report message or may be transmitted in a separate message. Additionally, or as an alternative, the UE 310 may determine an identifier of the RRD 330 and may transmit the identifier to the location server 350. In turn, the location server 350 may determine the position of the RRD 330 based on the identifier. Additionally, or as an alternative, the UE 310 may indicate in the measurement report message that, from a same base station, one PRS has been received via an RRD and another PRS has been received without being reflected at the RRD. Based on a knowledge concerning positions of the base stations and RRDs, the location server 350 may determine the position of the RRD 330 at which the one PRS has been reflected.

The geometric calculations may include the following: Based on the positioning information, for example the time of arrival or the time difference of arrival of the PRSs 361 to 363, received in the measurement report message(s) from the UE 310, the location server 350 may determine a time of flight T1 of PRS 361 along the LOS from BS 340 to UE 310, a time of flight T2 of PRS 362 along the LOS from BS 320 to UE 310, and a time of flight T3 of PRS 363 along the LOS from BS 320 to RRD 330 and along the LOS from RRD 330 to UE 310. Based on T1 and the propagation speed of radio signals (essentially the speed of light), a distance D1 between BS 340 and UE 310 can be determined. Likewise, based on T2, a distance D2 between BS 320 and UE 310 can be determined. Based on T3 the propagation path lengths D3 from BS 320 via RRD 330 to UE 310 can be determined. Thus, D3 corresponds to the sum of the distance D31 between BS 320 and RRD 330 and the distance D32 between RRD 330 and UE 310. As the positions of BS 320 and RRD 330 are known, the distance D31 between BS 320 and RRD 330 is also known. Distance D32 between RRD 330 and UE 310 can be calculated by subtracting D32 from D3. The positions of BS 320, BS 340 and RRD 330 are known. Each distance from UE 310 to BS 320, RRD 330 and BS 340, respectively, is determined. Based on these positions and distances, the position of UE 310 may be determined, for example by trilateration or multilateration in case of more positioning information.

It is to be noticed that functionality of determining the position of the UE 310 may be implemented at the location server 350 only, or may be implemented in a distributed way at the involved BSs 320, 340 and the location server 350, or may be implemented in a distributed way at the involved BSs 320, 340 only. Therefore, in the claims and the following description, the term “positioning node” is used which represents any of the above described implementation of the functionality for determining the position of the UE 310 in the involved BSs 320, 340 and/or the location server 350.

As a result, the UE 310 reports information based on two receive timing values of PRS 362, 363 received from the same BS 320. It is clear that the two receive timing values relate to the same positioning occasion. In combination with the timing value of PRS 361, which relates to the same positioning occasion also, the position of the UE 310 can be calculated although only two base stations 320, 340 are involved. However, more than two base stations may be involved in the positioning of the UE 310. In that case, the PRS received via the RRD may contribute to increase the accuracy of the positioning.

As explained in the introductory part above, usually any reflected PRS is removed from consideration as it is assumed that such PRS has unintentionally arrived at the UE, for example as a reflection at an environmental object. Therefore, the UE may request for permission to report timing values based on two PRS received from a same base station within the same positioning occasion. The BS or location server may grant or reject such a request in a corresponding response message to the UE.

In further examples, the location server 350 and/or the BSs 320, 340 may be aware of the presence of an RRD, for example RRD 330. For example, a position of the RRD may be stored in a database which is accessible by the location server 350 and/or the BSs 320, 340. Further information concerning the RRD, for example an orientation and capabilities concerning angles of reflection, may be stored in a database also. The BS 320 may direct one of its beams towards the RRD 330, for example beam 304 as indicated in FIG. 3. A signal transmitted in the direction of a beam may include an identifier identifying the beam in which with which the signal is emitted at the BS 320. Additionally, the BS 320 may inform the UE 310 that it should always report the time measurements concerning the beam directed to the RRD. In the example of FIG. 3, the BS 320 may inform the UE 310 that it should always report time measurements when receiving PRS transmitted in beam 304. In this case, if UE 310 receives PRSs 362 and 363 from BS 320 via beams 303 and 304, UE 310 reports two time measurements concerning PRSs received via beams 303 and 304. Additionally, in certain scenarios, UE 310 may receive PRS 362 transmitted in beam 303 twice also, once along an LOS path and once along a path unintentionally reflected at an environmental object. However, as the UE 310 was not instructed that it should always report time measurements when receiving PRS transmitted in beam 303, UE 310 may report the time measurements concerning the first arrival of PRS 362 only, assuming that this is the PRS along the LOS. Likewise, in case the UE 310 receives another PRS transmitted in another beam, for example beam 302, which has been reflected at an environmental object, UE 310 does not report time measurement concerning this other PRS, as the PRS 362 from the same BS 320 has arrived before the PRS of beam 302. To sum up, in this example, in case the UE 310 receives several PRSs from a same BS 320, the UE 310 only reports time measurements concerning the PRS which has arrived at first at the UE 310, assuming that this PRS has traveled along a line of sight from the BS 322 the UE 310, and additionally time measurements concerning the PRS which has been transmitted in the beam previously indicated by the BS 320, for example beam 304 in FIG. 3.

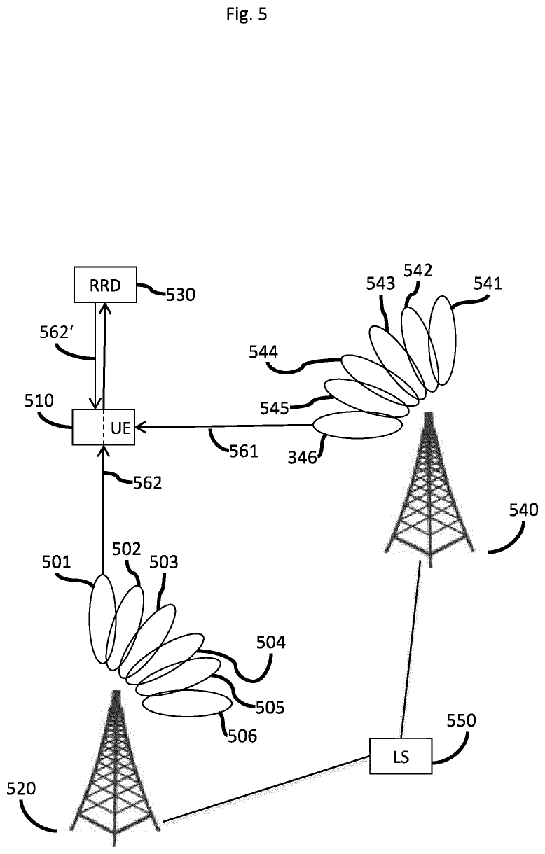

FIG. 5 shows a further scenario for determining a position of a UE 510. As illustrated, DL TX beams 501-506 are used by BS 520. Here, the BS 520 activates the beams 501-506 on different resources (e.g., different time-frequency resources, and/or using orthogonal codes/precoding) such that the UE 510 can monitor and identify respective signals transmitted on the DL TX beams 501 - 506. The signals transmitted on the DL TX beams 501 to 506 may comprise PRSs.

A further BS 540 may also activate beams 541 to 546 on different resources such that the UE 510 can monitor and identify respective signals transmitted on the DL TX beams 541 for 546. The signals transmitted on the DL TX beams 541 to 546 may also comprise PRSs. One or more further BSs may be present, but are not shown for reasons of clarity.

Transmission of the PRSs in the DL TX beams 501 to 506 and 541 to 546 may be coordinated and synchronized by a location server (LS) 550 coupled to BS 520 and BS 540.

In the scenario shown in FIG. 5, a position of UE 510 may be determined based on PRSs 561, 562 along LOS paths from BSs 520 and 540, and PRS 562′ along a path reflected at RRD 530.

In particular, PRS 562 is transmitted by BS 520 on beam 501. PRS 562 propagates to UE 510 and beyond UE 510 to RRD 530. At RRD 530, PRS 562 is reflected as PRS 562′. As a result, PRS 562 is received at UE 510 twice: once along the direct LOS path and once as reflected PRS 562′ from RRD 530. UE 510 may be aware of the fact that PRS 562 is received directly from BS 320 along LOS and as reflected PRS 562′ from RRD 530. Therefore, UE 510 may report timing measurements concerning both, PRS 562 and PRS 562′. For example, based on receive beams established at UE 510, UE 510 may determine that PRS 562′ has been reflected at RRD 530. In another example, UE 510 may have received a message indicating that it should report any timing measurement concerning any PRS from BS 520, or at least any timing measurement concerning any PRS in beam 501 from BS 520. Such a message may be transmitted from the location server 550 via the BS 520 to UE 510 based on information that beam 501 of BS 520 is directed to RRD 530.

In the above example, in which different receive beams are needed to receive PRS 562 along the LOS path and PRS 562′ along the path reflected at RRD 530, both PRSs may arrive in the same OFDM symbol. Therefore, UE 510 may need to listen on both receive beams simultaneously to properly receive them. This may not be possible in any UE as the number of receiver chains may be limited. In such a case, the UE must choose to receive either PRS along LOS or PRS reflected at RRD 530. However, as the PRSs are periodically transmitted, this problem may be alleviated. The UE may alter between reception of the LOS and the RRD reflected signal. For compensating a corresponding reduced accuracy, the UE may request to increase the number of PRS transmissions per time for a corresponding beam, for example beam 501 in FIG. 5.

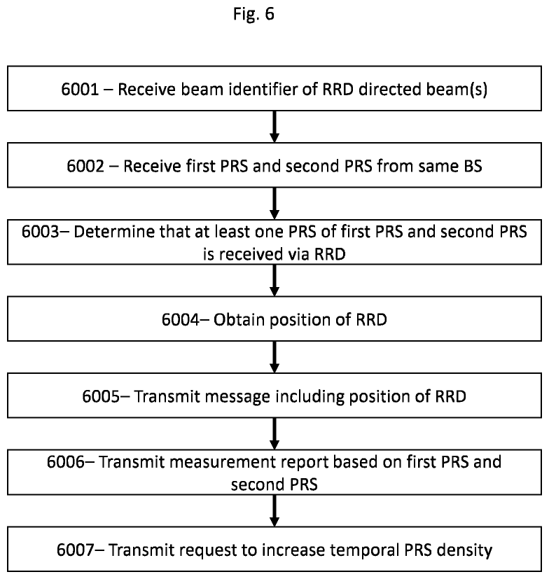

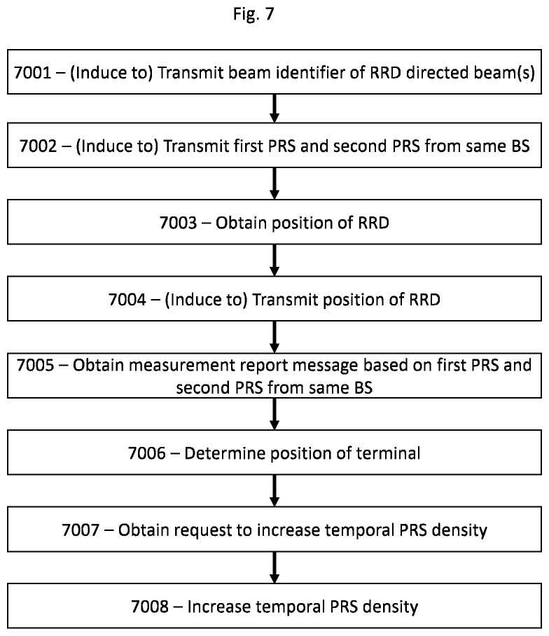

For implementing the above described techniques, method steps as shown in FIG. 6 may be performed by a UE, and method steps as shown in FIG. 7 may be performed by a positioning node, for example a location server or a base station or a combination thereof.

It is to be noticed that, depending on the various exemplary techniques described above, some of the method steps described below in connection with FIG. 6 and FIG. 7 are optional and may therefore be omitted. Furthermore, the method steps may be performed in any other order than described in the FIG. 6 and FIG. 7 as appropriate.

In step 7001, a positioning node of the network, for example the location server 350 or BS 320 or a combination thereof, transmits a message to a UE, for example UE 310, indicating a beam identifier which identifies a specific transmit beam of the BS, which is directed to an RRD, and comprising an instruction for the UE to include any PRS received in a specific transmit beam into measurement report messages when receiving PRS in the specific transmit beam. For example, location server 350 may instruct BS 320 to transmit such a message to UE 310. The message may indicate a beam identifier of beam 304 which is directed towards the RRD 330 as the specific transmit beam. Additionally, location server 350 may instruct BS 320 to transmit a PRS in the specific transmit beam 504 and to transmit at least one further PRS in another transmit beam directed in another direction than the specific transmit beam, for example in the direction of transmit beam 303.

In step 6001, UE 310 may receive the message indicating a beam identifier which identifies the specific transmit beam. The UE 310 may store the indicated beam identifier in memory 212 and may use this information as described below when deciding which PRS timing information is to be included into reports transmitted to the network.

In step 7002, the BS 320 may transmit PRSs in its various transmit beams, e.g. as instructed by the location server 350. The location server 350 may instruct further base stations to transmit PRSs within a same positioning occasion. For example, the PRSs from the different base stations may be transmitted essentially at the same time, within a same transmission frame or timeslot, or within a predefined number of consecutive subframes, thus defining a positioning occasion.

In step 6002, UE 310 receives PRSs from various base stations, for example from BS 320 and BS 340. In particular, UE 320 may receive a first PRS 363 and a second PRS 362 from the same BS 320. The first PRS 363 is the received along a propagation path which is reflected at RRD 330. The second PRS 362 is received a propagation path which is not reflected at the RRD 330. For example, the second PRS 362 may be received along a line of sight between the BS 320 and the UE 310.

In step 6003, the UE 310 may determine whether the first PRS and the second PRS are received from the same network node. For example, the UE 310 may determine this based on characteristics of the PRSs, for example radio resources in which the PRSs are transmitted, or based on information included in the PRSs. The UE 310 may furthermore determine whether the first PRS is received along a propagation path which is reflected at the RRD 330 and whether the second PRS is received along a propagation path which is not reflected at the RRD 330. For example, based on the beam identifier received in step 6001, the UE 310 may determine whether the received PRSs are received via RRD 330 or not. In other examples, as discussed above in connection with FIG. 3 and FIG. 5, the UE 310 may determine whether the received PRSs are received via RRD 330 or not based on the received PRS itself, for example based on a “flicker” or an angle of arrival of the PRS 363 and a position of RRD 330. The position of RRD 330 may be determined in step 6004 based on a short-range radio communication between the UE 310 and the RRD 330. For example, the RRD 330 may communicate its position to UE 310 via a short-range radio communication. In another example, the position of the RRD 330 may be determined by the UE 310 based on an angle of arrival of PRS 363 and an estimate of the distance between UE 310 and RRD 330 based on the short-range radio communication.

In particular, in cases where the UE 310 has obtained a position of RRD 330, for example by communicating with the RRD 330 via a short-range radio communication, the UE 310 may transmit a message including the position of the RRD 330 in step 6005 to the network, for example to the location server 350 via BS 320 or any other BS. Thus, in step 7003, the location server 350 may obtain a position of the RRD 330.

On the other hand, in particular in cases where the location server has knowledge about the position of the RRD 330, for example by a database retrieval, the location server 350 may transmit, or may induce to transmit, in step 7004 a message to the UE 310 indicating the position of RRD 330. Thus, additionally or as an alternative, the UE 310 may obtain the position of the RRD 330 in step 6004 from corresponding information included in the message transmitted by the location server 350 in step 7004.

In another example, the UE 310 may determine an identifier of the RRD 330, for example based on a short-range radio communication with the RRD 330, and UE 310 may transmit the identifier in step 6005 to the location server 350 which receives the identifier of RRD 330. Based on the identifier, the location server 350 may obtain a position of the RRD 350 in step 7003, for example based on a database retrieval.

In step 6006, the UE 310 transmits a measurement report message to the location server 350, for example via any of the base stations 320, 340. In case UE 310 has determined that the first PRS is received along a path reflected at the RRD and the second PRS has not been reflected at the RRD 330, the measurement report message comprises positioning information based on the first PRS and the second PRS. In other words, although the first PRS and the second PRS have been received from the same BS 320, they are both reported to the location server 350. The measurement report may comprise an indication indicating that the first PRS and the second PRS have been received from the same BS, for example BS 320. The measurement report may comprise an indication indicating that the first PRS has been received via RRD 350. The positioning information may include timing values relating to times of reception of the first and second PRSs. For example, a time difference of arrival between the arrival times of the first and second PRSs or any time difference of arrival between the arrival times of any of the first and second PRSs and any other PRSs from another base station may be included.

The location server 350 obtains in step 7005 the measurement report message from the UE 310, for example via any one of the BSs 320, 340. Based on the positioning information included in the measurement report message and the position of the RRD 330, the location server 350 determines in step 7006 the location of the UE 310, for example by geometric calculations.

In a further example, the UE 310 may merely indicate, for example in the message transmitted in step 6005 or in the measurement reports in step 6006, that it has received a PRS via an RRD. Based on this indication, the location server 350 may obtain in step 7003 the position of the RRD, for example by a database retrieval. For example, based on the positioning information for the terminal node included in the measurement report message received in step 7005 and the positions of the involved base stations 320, 340, the location server may retrieve from the database an RRD having a suitable position and may consider the position of the thus determined RRD for determining the position of the UE 310 in step 7006.

In particular in case the location server 350 has instructed in step 7001 that the UE 310 includes any PRS received in a specific transmitted beam into the positioning information included measurement report message, the location server may determine in step 7006 whether the first PRS is received along a propagation path which is a reflected at the RRD 350 and whether the second PRS is received along a propagation path which is not reflected at the RRD 350. If affirmative, the location server 350 may determine the position of the UE 310 based at least on the positioning information relating to the first PRS, the second PRS and the position of the RRD.

As discussed above in connection with FIG. 5, it may be advantageous in certain scenarios to increase the temporal density of the transmission of PRSs. To accomplish this, the UE 510 may transmit in step 6007 a request to the location server 350 to increase the temporal density of the transmission of PRSs, in particular the temporal density of the transmission of the PRS 562 in beam 501. The location server 550 may obtain the request to increase the temporal PRS density in step 7007, for example via any of BS 320, 340. In step 7008, the location server increases the temporal PRS density as required, for example by instructing BS 520 accordingly.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of operating a terminal node configured to communicate with one or more network nodes using a re-configurable relaying device (RRD) the RRD being re-configurable to provide spatial filters, each one of the spatial filters being associated with a respective spatial direction into which incident signals are selectively transmitted by the RRD, the method comprising:
receiving a plurality of positioning reference signals (PRSs) transmitted by the one or more network nodes, and
upon a first PRS and a second PRS of the plurality of PRSs being received from a same network node of the one or more network nodes, the first PRS being received along a path which is relayed at the RRD: transmitting a measurement report message comprising positioning information for the terminal node based on at least the first PRS and second PRS.

2. The method of claim 1, further comprising:
determining whether the first PRS and the second PRS are received from the same network node, whether the first PRS is received along a path which is relayed at the RRD and whether the second PRS is received along a path which is not relayed at the RRD, and
transmitting the measurement report message comprising positioning information for the terminal node based on at least the first PRS and second PRS in case the first PRS and the second PRS are received from the same network node, the first PRS is received along a path which is relayed at the RRD and the second PRS is received along a path which is not relayed at the RRD.

3. The method of claim 2, wherein the path which is not relayed at the RRD is a path along a line of sight between the same network node and the terminal node.

4. The method of claim 1, further comprising:
determining the position of the RRD based on PRSs received from one network node of the one or more network nodes via the RRD.

5. The method of claim 1, wherein the measurement report message further comprises further information indicative of at least one of a position, an identity, or a presence of the RRD.

6. The method of claim 1, further comprising:
receiving a message from a network node of the one or more network nodes indicative of the position of the RRD.

7. The method of claim 1, further comprising
transmitting a message to a network node of the one or more network nodes indicative of the position of the RRD.

8. The method of claim 1, wherein the measurement report message comprises a time difference of arrival of the first PRS and the second PRS.

9. The method of claim 1, further comprising
receiving a message from a network node of the one or more network nodes indicative of a beam identifier identifying a specific transmit beam of the network node directed towards the RRD and an instruction for the terminal node to include into the measurement report message any PRSs received in the specific transmit beam.

10. The method of claim 9, further comprising:
transmitting a request to the network node for increasing a temporal density of PRSs transmitted in the specific transmit beam.

11. The method of claim 1, wherein the measurement report message comprises an indication indicating that the positioning information is based on least a first PRS and a second PRS received from a same network node.

12. A method of operating a positioning node configured to communicate with one or more terminal nodes using a re-configurable relaying device (RRD) the RRD being re-configurable to provide spatial filters, each one of the spatial filters being associated with a respective spatial direction into which incident signals are selectively transmitted by the RRD, the method comprising:
obtaining a measurement report message comprising positioning information for a terminal node of the one or more terminal nodes, the positioning information being based on at least a first PRS and a second PRS received from a same network node, the first PRS being received along a path which is relayed at the RRD, and
determining a position of the terminal node based on the positioning information and a position of the RRD.

13. The method of claim 12, wherein the measurement report message further comprises further information indicative of at least one of the position, an identity, or a presence of the RRD.

14. The method of claim 12, further comprising:
determining the position of the RRD by a database retrieval based on an identity of the RRD.

15. The method of claim 12, further comprising:
obtaining a message from a terminal node of the one or more terminal nodes indicative of the position of the RRD.

16. The method of claim 12, further comprising:
transmitting a message to a terminal node of the one or more terminal nodes indicative of the position of the RRD.

17. The method of claim 12, further comprising:
transmitting a message to a terminal node of the one or more terminal nodes indicative of a beam identifier identifying a specific transmit beam of a network node directed towards the RRD and an instruction for the terminal node to include into the measurement report message positioning information including any PRS received in the specific transmit beam.

18. The method of claim 17, further comprising:
obtaining a request from the terminal node for increasing a temporal density of PRSs transmitted in the specific transmit beam.

19. The method of claim 17, further comprising:
inducing a network node to transmit a PRS in the specific transmit beam, and
inducing the same network node to transmit at least one further PRS in another transmit beam directed in a direction other than the specific transmit beam.

20-23. (canceled)

24. A terminal node comprising an antenna arrangement, a transceiver and control circuitry configured to
communicate with one or more network nodes using a re-configurable relaying device (RRD) the RRD being re-configurable to provide spatial filters, each one of the spatial filters being associated with a respective spatial direction into which incident signals are selectively transmitted by the RRD,
receive a plurality of positioning reference signals (PRSs) transmitted by the one or more network nodes, and
upon a first PRS and a second PRS of the plurality of PRSs being received from a same network node of the one or more network nodes, the first PRS being received along a path which is relayed at the RRD: transmit a measurement report message comprising positioning information for the terminal node based on at least the first PRS and second PRS.

25-27. (canceled)
